(19) United States
(12) Patent Application Publication
(10) Pub. No.: US 2003/0155181 A1
(43) Pub. Date: Aug. 21, 2003

(54) Crankcase drain method and apparatus

(76) Inventor: Kerry A. Reinke, Canon City, CO (US)

Correspondence Address: RICK MARTIN, PATENT LAW OFFICES OF RICK MARTIN, PC, 416 COFFMAN STREET, LONGMONT, CO, 80501, US

(21) Appl. No.: 10/368,181

(22) Filed: Feb. 18, 2003

Related U.S. Application Data
(60) Provisional application No. 60/357,300, filed on Feb. 15, 2002.

(51) Int. Cl. F16C 3/14

(52) U.S. Cl. 184/1.5

(57) ABSTRACT

Marine engines often do not provide access to the crankcase drain plug. A conduit is screwed into the crankcase oil filter port to replace the standard oil filter to execute an oil change. The conduit is shaped like an oil filter and has a large orifice exit port on the bottom which receives a garden hose. The engine is cold cranked to push the oil out the crankcase oil filter port. Then the conduit is replaced with a new oil filter. An alternate embodiment incorporates the orifice and valve into the bottom of a standard oil filter.

### CROSS REFERENCE APPLICATIONS

This application is a non-provisional application claiming the benefits of provisional application no. 60/357,300 filed Feb. 15, 2002.

### FIELD OF INVENTION

The present invention relates to using the starter in an internal combustion engine to crank the engine, thereby quickly forcing substantially all the crankcase oil out of a large orifice in a drainage receptacle which is temporarily fitted to the oil filter mount on the engine.

### BACKGROUND OF THE INVENTION

Replacing crankcase oil in marine engines has long been a time consuming and/or messy business. The crankcase drain plug is usually inaccessible. Oftentimes a small tube is forced down the oil level orifice. A small electric pump is used to draw the old oil out the small tube. This process requires a pump, which has an associated cost. The process is also time consuming due to the flow limitation caused by the narrow tube needed to fit down the oil level orifice.

Another relevant invention is seen in U.S. Pat. No. 5,366,400 (1994) to Kucik. A standard oil filter cartridge is modified with an oil outlet valve at the base. A narrow outlet tube with a manually activated shutoff valve is designed to allow the residual oil in the oil filter cartridge to drain out before removing the oil filter cartridge. Kucik does not suggest using his invention to drain all the crankcase oil out of the outlet port of his special filter cartridge. Kucik's outlet port is too narrow to function as a suitable crankcase drain.

The present invention's preferred embodiment is a canister used only to change the crankcase oil. The canister is fitted to the engine's oil cartridge port after the oil filter cartridge is removed. Then the coil is disabled, or in a diesel the choke is turned on, thereby defeating ignition. Next the outlet port of the canister is connected to a storage container. Then the engine is cold-cranked to use the starter motor to circulate the crankcase oil out the canister quickly. When the oil is drained, a new oil filter is installed, and the new oil can be added the engine.

### SUMMARY OF THE INVENTION

The primary aspect of the present invention is to provide an oil removal canister for an engine, wherein the canister can be installed on the oil filter boss, thereby enabling a cold cranking of the engine to pump substantially all the crankcase oil out the canister.

Another aspect of the present invention is to provide a shut-off valve on the canister.

Another aspect of the present invention is to design an oil filter cartridge with an exit port having a shutoff valve, wherein the exit port is wide enough to enable a cold cranking of the engine to pump out the crankcase oil.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

FIG. 1 is a side perspective view of the preferred embodiment crankcase drain funnel.

FIG. 2 is an exploded view of a first alternative embodiment.

FIG. 3 is a side perspective view of the first alternative embodiment in use.

FIG. 4 is a side view with partial cutaway of a second alternative embodiment.

### DESCRIPTION OF THE PREFERRED EMBODIMENT

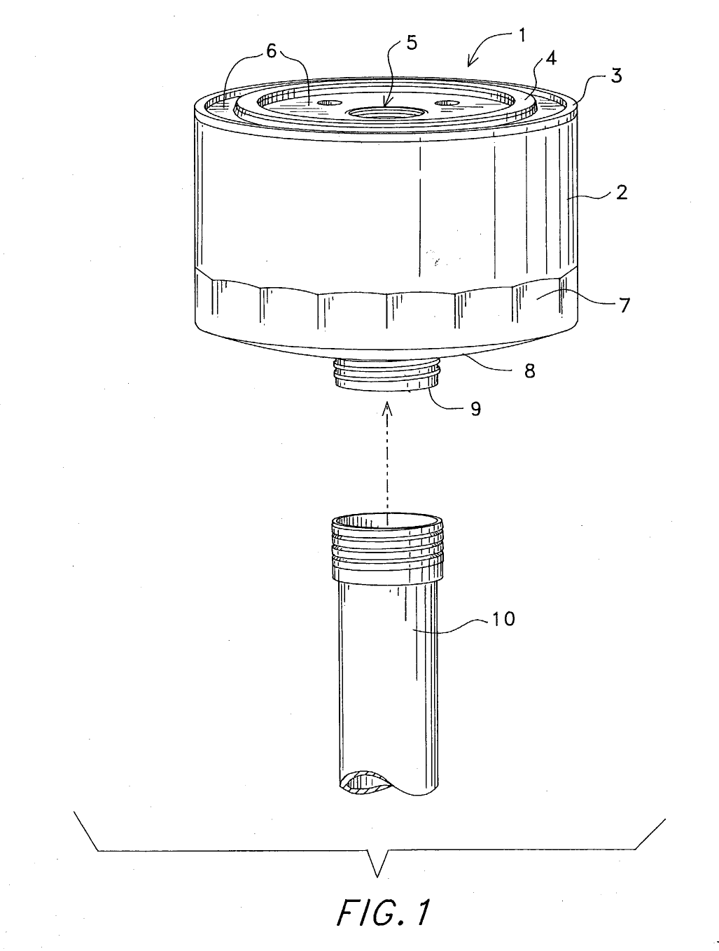

Referring to FIG. 1 an oil drainage conduit 1 comprises a cylindrical body 2 having finger indents 7 along a bottom edge, similar to standard oil filters in order to facilitate screwing the conduit into an engine crankcase port. The top of the conduit 1 has a central threaded orifice 5 with the same dimensions and threads as a standard oil filter. A top surface 6 has a gasket 4 and an outer periphery 3 the same as a standard oil filter.

In operation an oil filter is removed and the conduit is quickly threaded on before too much oil exits the crankcase oil port. Once installed the conduit 1 receives oil through orifice 5 into its hollow body 2 and discharges the oil out the large (about one inch O.D. and ⅞″ I.D.) exit port 9 which extends from the bottom 8 of the conduit. Preferably, a garden hose 10 has been screwed onto the exit port 9 to direct the old oil into a container.

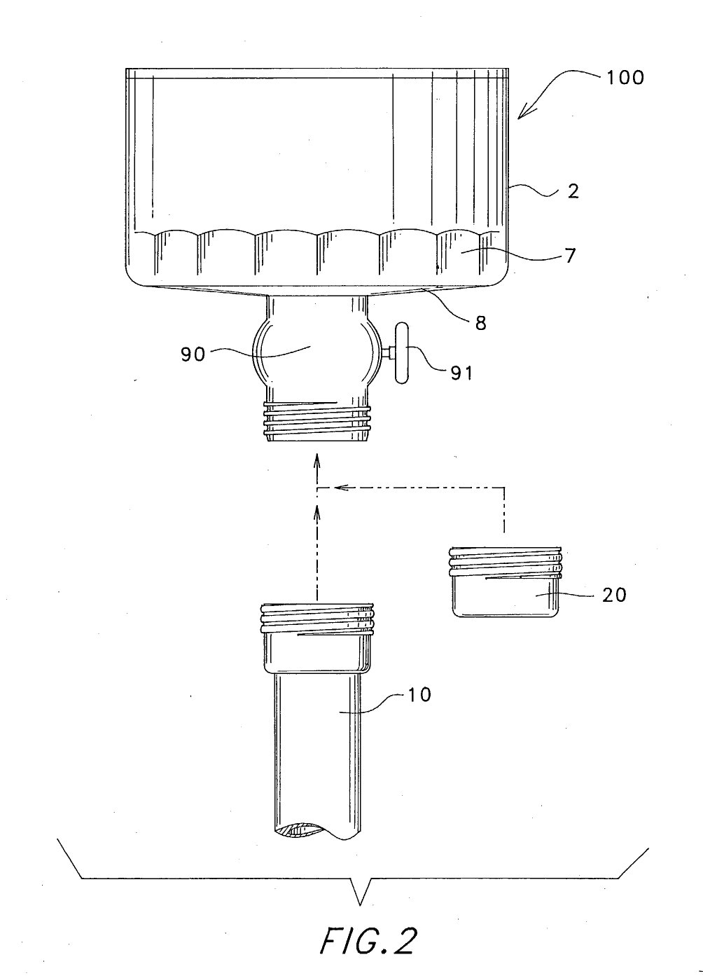

In order to drain almost all the oil from the engine, the engine is cold cranked with the ignition OFF, thereby using the starter motor to circulate the crankcase oil out the crankcase port. A cap 20 (FIG. 2) may be used for added convenience. The above described method and apparatus facilitates changing the oil on a boat where the crankcase oil drain plug is not accessible.

Referring next to FIG. 2, a slightly more sophisticated conduit 100 has an equivalent cylindrical body 2, but an exit port 90 has a manual shut-off valve 91 which adds convenience to hooking up the garden hose 10 in preventing a spill. Of course, a user could pre-hook up the garden hose 10 to the exit port (9 or 90) to minimize spillage.

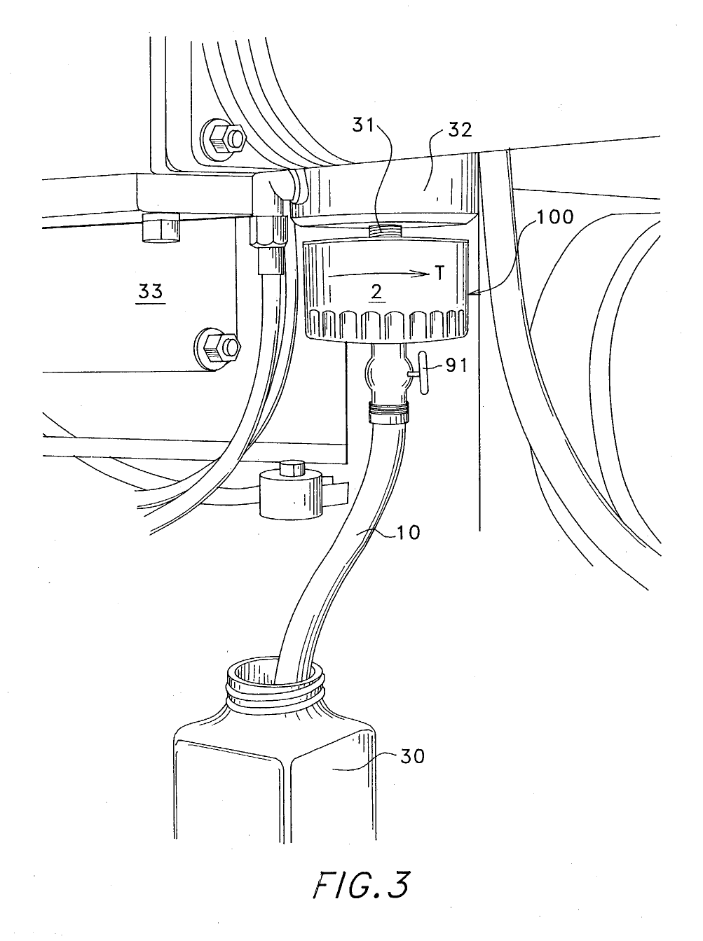

Referring next to FIG. 3, an engine 33 has a crankcase 32 with an oil exit port (male) 31. The conduit 100 is being screwed on with a clockwise turn T. The valve 91 would be turned open as shown when the conduit is fully mounted on the exit port 31. The engine 33 would be cold cranked. The oil would flow down the garden hose 10 to the container 30.

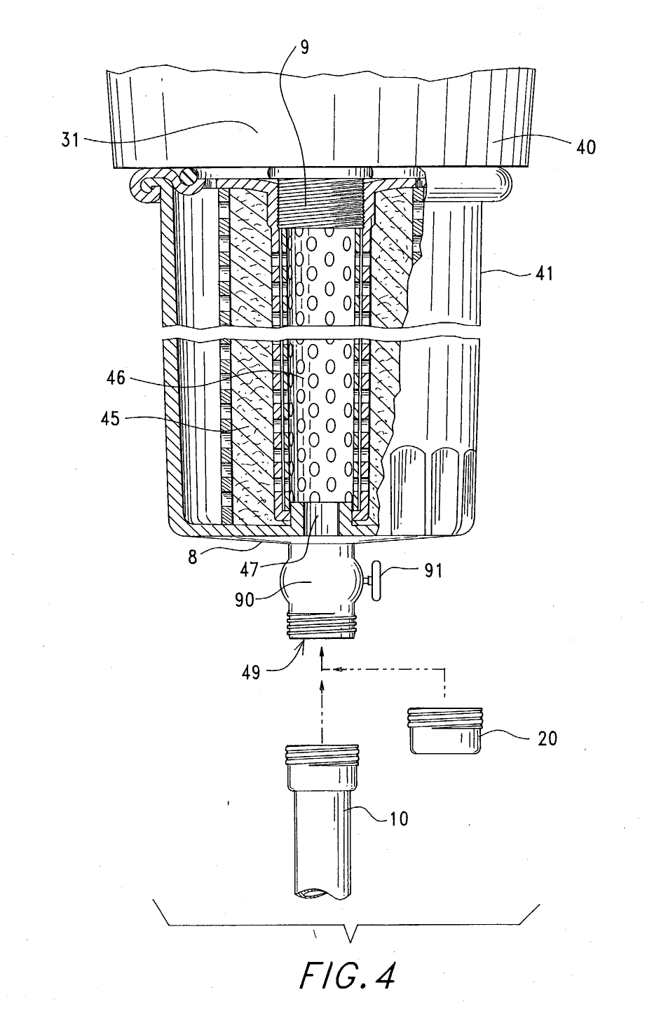

Referring next to FIG. 4, an oil filter 41 is made in a standard manner with a cylindrical shell and interior spout 46 which allows oil to flow into a filter media 45 and return to the crankcase 40. The bottom 8 has an exit port 90 as described above with an exit orifice 49 at least about 11/16″ I.D. wide (about the same I.D. as the spout 46) to allow a rapid outlet flow of dirty oil when doing an oil change. The same cold cranking procedure is used as noted above. The same valve 91, cap 20 and hose 10 are used to collect the dirty oil. The oil filter 41 is disposable after the dirty oil is drained.

Although the present invention has been described with reference to preferred embodiments, numerous modifications and variations can be made and still the result will come within the scope of the invention. No limitation with respect to the specific embodiments disclosed herein is intended or should be inferred.

I claim:

1. A crankcase funnel for providing a drainage of oil from a crankcase through an oil filter port, said funnel comprising:
a cylindrical, hollow conduit having a threaded inlet port on a top surface; said inlet port being surrounded by a gasket, thereby providing a leak-proof seal against an oil filter outlet port of an engine;
said top surface having a circular periphery sized to fit into the engine oil filter outlet port;
said hollow conduit having a hollow central core and an elongate body with a lower outer periphery having indents for grabbing and turning;
said hollow conduit having a closed bottom surface with an outlet port sized at about ⅞″ I.D. or greater to enable a rapid flow of oil therethrough when the engine is cold cranked; and
a removable closure for the outlet port and/or a shut-off valve therefor.

2. The funnel of claim 1, wherein the outlet port further comprises a garden hose connector thread on its outside edge.

3. The funnel of claim 2 further comprising a garden hose removably connected to the garden hose connector thread.

4. The funnel of claim 2, wherein the removable closure further comprises a threaded cap.

5. A crankcase funnel comprising:
a hollow conduit means functioning to thread into an engine's oil filter port and allow a discharge of engine oil therethrough;
said hollow conduit means further comprising a round top surface having a female threaded hold surrounded by a gasket to engage the engine's oil filter port;
said hollow conduit means further comprising a cylindrical body means to allow oil to flow therethrough, with a finger grip pattern means functioning to provide a grip for a user to twist;
said hollow conduit means further comprising a round bottom surface having an oil outlet port means at least about ⅞″ I.D. to allow a rapid oil discharge when the engine is cold cranked; and
said oil outlet port means having a closure means functioning to controllably open and close the oil outlet port means.

6. The funnel of claim 5, wherein the closure means further comprises a threaded cap.

7. The funnel of claim 5, wherein the closure means further comprises a valve.

8. The funnel of claim 5, wherein the closure means further comprises a garden hose removably connected to the oil outlet port.

9. A replaceable oil filter cartridge comprising:
a cylindrical conduit body having an internal oil filter apparatus;
said cylindrical conduit body having a round bottom surface with an oil outlet port at least about ⅞″ I.D. wide; and
said oil outlet port having a closure means functioning to controllably open and close the oil outlet port.

10. The cartridge of claim 9, wherein the closure means further comprises a threaded cap.

11. The cartridge of claim 9, wherein the closure means further comprises a valve.

12. The cartridge of claim 9, wherein the closure means further comprises a garden hose removably connected to the oil outlet port.

13. A method to drain oil from an engine crankcase, the method comprising the steps of:
removing an oil filter from an engine's oil filter outlet;
installing by means of threading a funnel into the engine's oil filter outlet;
using as the funnel a metal, hollow conduit shaped like the oil filter and having an exit hole being at least about ⅞″ in inside diameter;
cold cranking the engine to force the oil out the funnel; and
installing a new oil filter.

14. The method of claim 13 further comprising the step of removing a closure on the exit hole before cold cranking the engine.

15. The method of claim 13 further comprising the step of affixing a garden hose to the exit hole.

16. The method of claim 13 further comprising the step of opening a shut-off valve on the exit hole before cold cranking the engine.
